(19) United States
(12) Patent Application Publication
(10) Pub. No.: US 2026/0341615 A1
(43) Pub. Date: Oct. 29, 2026

(54) CIRCUIT BREAKER

(71) Applicant: Schneider Electric Industries SAS, Rueil-Malmaison (FR)

(72) Inventors: Ming WANG, Shanghai (CN); Zhigang HAN, Shanghai (CN)

(21) Appl. No.: 19/650,823

(22) Filed: Apr. 17, 2026

(30) Foreign Application Priority Data
Apr. 25, 2025 (CN) 2025105302190

(51) Int. Cl. H01H 33/70

(52) U.S. Cl. CPC H01H 33/70

(57) ABSTRACT

A circuit breaker includes opposing first and second ends. Between the ends are first and second sets of moving and fixed contacts, and first and second arc extinguishing chambers each having a front side close to and a rear side distant from the respective set of moving and fixed contacts. A first air flow channel starts from the rear side of the first arc extinguishing chamber and a second air flow channel starts from the rear side of the second arc extinguishing chamber, with outlets of both channels arranged at the second end. A first arc protection element is arranged at the first end between the rear side of the first arc extinguishing chamber and the outer surface of the first end wall.

### CROSS-REFERENCE

This application claims priority to Chinese Patent Application No. 2025105302190, filed on Apr. 25, 2025, and entitled “CIRCUIT BREAKER”, the entirety of which is incorporated herein by reference.

### TECHNICAL FIELD

The present disclosure relates to circuit breakers, and more particularly to the arc extinguishing structure design of circuit breakers.

### BACKGROUND

In electrical systems, circuit breakers serve as important protective devices, and their safety is crucial. However, existing circuit breakers present safety risks during operation. When a short circuit or similar fault occurs during the circuit breaking process of the circuit breaker, high-temperature and high-pressure gas is generated in the arc extinguishing chamber. These gases, when expelled from the arc extinguishing chamber outlet, often carry arcs, forming an “arc flash” phenomenon. Arc flashes not only damage the circuit breaker itself, but also significantly affect other components near the circuit breaker, causing damage such as burning, short circuits, etc., which may further lead to wider electrical failures.

To reduce the impact of arc flash on other components inside the electrical cabinet, circuit breakers are typically provided with a certain arc flash safety distance or provided with terminal covers. However, this increases the overall size of the circuit breaker and limits its application in compact spaces.

Therefore, how to effectively reduce the impact of arc flash on components near the circuit breaker while not increasing the size of the circuit breaker has become an urgent technical problem to be solved.

### SUMMARY

In response to the problems and needs mentioned above, the present disclosure provides a circuit breaker comprising a first end and a second end opposing each other, and components located between the first end and the second end, including: a first set of moving and fixed contacts; a first arc extinguishing chamber having a front side close to the first set of moving and fixed contacts and a rear side distant from the first set of moving and fixed contacts; a second set of moving and fixed contacts; a second arc extinguishing chamber having a front side close to the second set of moving and fixed contacts and a rear side distant from the second set of moving and fixed contacts. The circuit breaker further comprises a first air flow channel starting from the rear side of the first arc extinguishing chamber and a second air flow channel starting from the rear side of the second arc extinguishing chamber, with the outlets of both the first air flow channel and the second air flow channel arranged at the second end. A first arc protection element is arranged at the first end, located between the rear side of the first arc extinguishing chamber and the outer surface of the first end wall of the first end.

According to an exemplary embodiment, a groove is arranged in the first end wall of the first end, and the first arc protection element is installed in the groove.

According to an exemplary embodiment, the first arc protection element is a plate-like element with multiple through-holes.

According to an exemplary embodiment, the first arc protection element is a metal woven mesh or a metal perforated plate.

According to an exemplary embodiment, the second air flow channel and the first air flow channel lead to the same outlet.

According to an exemplary embodiment, a second arc protection element is arranged in the junction area of the first air flow channel and the second air flow channel.

According to an exemplary embodiment, the second arc protection element includes one or more arc protection mesh surfaces arranged to allow gas from the first air flow channel and/or the second air flow channel to pass through.

According to an exemplary embodiment, at least one of the one or more arc protection mesh surfaces also serves as an air flow guiding surface, the air flow guiding surface having a curved surface to guide the gas in the second air flow channel toward the direction of the outlet.

According to an exemplary embodiment, the second arc protection element further includes a fixing surface engaging the channel side wall to assist in fixing the second arc protection element.

According to an exemplary embodiment, the second arc protection element is formed by bending a metal plate-like element.

According to an exemplary embodiment, the outlet includes a first outlet and a second outlet, the junction area includes a first junction area and a second junction area leading to the first outlet and the second outlet respectively, and the second arc protection element is arranged in both the first junction area and the second junction area.

According to an exemplary embodiment, the outlet is arranged at the bottom of the circuit breaker.

The preferred embodiments of the present disclosure will be described in more detail below in conjunction with the drawings, so that the features and advantages of the present disclosure can be easily understood.

### BRIEF DESCRIPTION OF THE DRAWINGS

To more clearly illustrate the technical solutions of the embodiments of the present disclosure, the drawings of the embodiments of the present disclosure are briefly introduced below. It should be noted that the drawings merely show some embodiments of the present disclosure, and the present disclosure is not limited to these embodiments.

FIG. 1 is a cross-sectional view of the circuit breaker according to an exemplary embodiment of the present disclosure;

FIGS. 2 and 3 are partial views of the circuit breaker according to an exemplary embodiment of the present disclosure, particularly showing the installation position of the first arc protection element;

FIG. 4 shows an exemplary embodiment of the first arc protection element of the present disclosure;

FIG. 5 shows an exemplary embodiment of the second arc protection element of the present disclosure;

FIG. 6 is a partial view of the circuit breaker according to an exemplary embodiment of the present disclosure, particularly showing the junction of the first air flow channel and the second air flow channel;

FIG. 7 is a partial view of the circuit breaker according to an exemplary embodiment of the present disclosure, particularly showing the branch structure at the end of the second air flow channel;

FIG. 8 is a partial view of the circuit breaker according to an exemplary embodiment of the present disclosure, particularly showing the branch structure at the end of the first air flow channel.

### LIST OF REFERENCE NUMERALS

10 First End
11 First Fixed Contact
111 Fixed Contact Assembly
12 First Moving Contact
13 First Arc Extinguishing Chamber
131 Front Side of First Arc Extinguishing Chamber
132 Rear Side of First Arc Extinguishing Chamber
14 First End Wall
15 First Air Flow Channel
151 First Air Flow Branch
16 Partition Structure
161 Flow Guidance Curved Surface
162 Latching Part
20 Second End
21 Second Fixed Contact
22 Second Moving Contact
23 Second Arc Extinguishing Chamber
24 Second End Wall
231 Front Side of Second Arc Extinguishing Chamber
232 Rear Side of Second Arc Extinguishing Chamber
25 Second Air Flow Channel
251 First Channel Part
252 Second Channel Part
26 Strip-like Guiding Part
30 Outlet
40 First Arc Protection Element
50 Second Arc Protection Element
51 First Arc Protection Mesh Surface
52 Second Arc Protection Mesh Surface
53 Third Arc Protection Mesh Surface
54 Fourth Arc Protection Mesh Surface
55 Fixing Surface

### DETAILED DESCRIPTION

To make the purpose, technical solution, and advantages of the technical solution of the present disclosure clearer, the technical solution of the embodiments of the present disclosure is clearly and completely described below in conjunction with the drawings of the specific embodiments. The same reference numerals in the drawings represent the same components. It should be noted that the described embodiments are only part of the embodiments of the present disclosure, not all of them. All other embodiments that can be obtained by a person skilled in the art without creative labor based on the described embodiments of the present disclosure are within the scope of protection of the present disclosure.

Compared with the embodiments shown in the drawings, the feasible implementation schemes within the scope of protection of the present disclosure may have fewer components, other components not shown in the drawings, different components, differently arranged components, or differently connected components, etc. In addition, two or more components shown in the drawings may be implemented in a single component, or a single component shown in the drawings may be implemented as multiple separate components.

Unless otherwise defined, technical terms or scientific terms used herein should be understood as having their usual meanings by those of ordinary skill in the art to which the present disclosure pertains. The terms “first”, “second”, and similar terms used in the present patent application specification and claims do not indicate any order, quantity, or importance, but are merely used to distinguish different components. Similarly, terms such as “a” or “an” do not necessarily indicate a limitation of quantity. The terms “comprising” or “containing” and similar terms mean that the element or object preceding these terms encompasses the elements or objects listed after these terms and their equivalents, without excluding other elements or objects. The terms “connected” or “connected to” and similar terms are not limited to physical or mechanical connections, but may include electrical connections, whether direct or indirect. The terms “upper”, “lower”, “left”, “right”, etc., are only used to indicate relative positional relationships, and the relative positional relationships may also change accordingly when the absolute position of the described object changes.

The present disclosure relates to a circuit breaker, particularly the arc extinguishing structure design of a double-breakpoint circuit breaker.

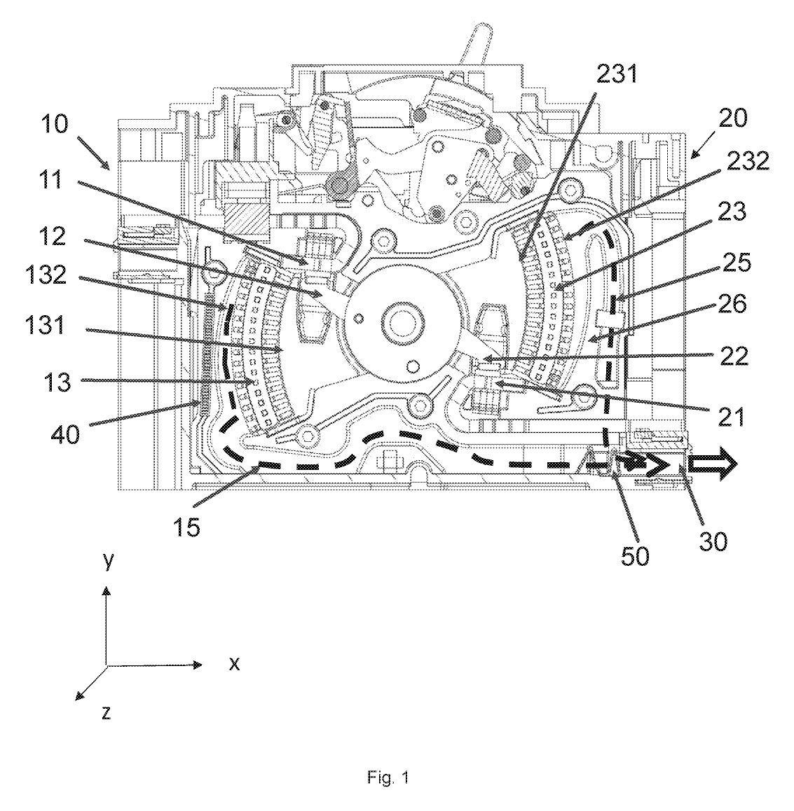

For clarity, the present disclosure will be described in reference to the coordinate system shown in FIG. 1. The x-direction corresponds to the length direction of the circuit breaker. The two ends of the circuit breaker, namely the first end 10 and the second end 20, are spaced apart from each other in the x-direction. The y-direction corresponds to the height direction of the circuit breaker, and the top and bottom of the circuit breaker are spaced apart from each other in the y-direction. The z-direction corresponds to the thickness direction of the circuit breaker, and the two main planes of the circuit breaker housing are spaced apart from each other in the z-direction. It should be understood that, in actual use of the circuit breaker, the horizontally displayed x-direction is not necessarily parallel to the ground.

As shown in FIG. 1, the double-breakpoint circuit breaker includes two sets of moving and fixed contacts, referred to as the first set of moving and fixed contacts and the second set of moving and fixed contacts. The first set of moving and fixed contacts includes a first fixed contact 11 and a first moving contact 12. The second set of moving and fixed contacts includes a second fixed contact 21 and a second moving contact 22. In this document, the first fixed contact 11 and the second fixed contact 21 may be collectively referred to as fixed contacts, and the first moving contact 12 and the second moving contact 22 may be collectively referred to as moving contacts.

The moving and fixed contacts are important components of the circuit breaker, which cooperate to control the connection and disconnection of the circuit. During the connection and disconnection process, the first fixed contact 11 and the second fixed contact 21 remain stationary, while the first moving contact 12 and the second moving contact 22 move toward or away from the first fixed contact 11 and the second fixed contact 21 respectively. For example, the first moving contact 12 and the second moving contact 22 may rotate around a common pivot axis to engage or disengage the first fixed contact 11 and the second fixed contact 21, thereby achieving the connection or disconnection of the circuit. In FIG. 1, the first set of moving and fixed contacts and the second set of moving and fixed contacts of the circuit breaker are in the engaged state.

During the separation process of the moving contact and the fixed contact, arcs are easily generated between them. In this disclosure, the area near the moving contact and the fixed contact where arcs are generated is referred to as the arc generation area. The generation of arcs can damage the moving and fixed contacts of the circuit breaker and/or other components.

To extinguish arcs, the circuit breaker further includes a first arc extinguishing chamber 13 close to the first set of moving and fixed contacts and a second arc extinguishing chamber 23 close to the second set of moving and fixed contacts. In this disclosure, the first arc extinguishing chamber 13 and the second arc extinguishing chamber 23 may be collectively referred to as arc extinguishing chambers.

The first arc extinguishing chamber 13 has a front side 131 close to the first set of moving and fixed contacts and a rear side 132 distant from the first set of moving and fixed contacts. Similarly, the second arc extinguishing chamber 23 has a front side 231 close to the second set of moving and fixed contacts and a rear side 232 distant from the second set of moving and fixed contacts. Each arc extinguishing chamber is arranged downstream of the corresponding arc generation area, and the arc can enter the arc extinguishing chamber through the front side of the arc extinguishing chamber. The arc extinguishing chamber may be used, for example, to stretch the arc length to extinguish the arc.

The present disclosure designs two special air flow channels for the circuit breaker, namely a first air flow channel 15 starting from the rear side 132 of the first arc extinguishing chamber and a second air flow channel 25 starting from the rear side 232 of the second arc extinguishing chamber. The first air flow channel 15 and the second air flow channel 25 may be collectively referred to as air flow channels. The air flow channels of the present disclosure have long lengths, and during the process of the gas carrying charged particles flowing along the air flow channels, the charged particles are gradually consumed, thereby reducing the impact of arcs on nearby equipment. Particularly, the present disclosure proposes that the outlets 30 of the first air flow channel 15 and the second air flow channel 25 are arranged at the same end of the circuit breaker, which is the second end 20 in the embodiment shown in the drawings. At the same time, the present disclosure arranges the first arc protection element 40 behind the rear side 132 of the first arc extinguishing chamber and in front of the outer surface of the first end wall 14 of the first end 10. By means of such design, a good arc extinguishing effect can be achieved, with zero arc flash at the first end and only a small amount of arc at the second end.

By arranging the outlets 30 of the first air flow channel 15 and the second air flow channel 25 at the same end of the circuit breaker, at least one air flow channel—in the embodiment shown in the drawings, the first air flow channel—can fully utilize the x-direction size of the circuit breaker to have a longer length, which is more conducive to reducing the metal particles emitted. Compared to the traditional scheme where the two outlets are arranged at the two opposite ends, arranging the outlets at the same end can avoid the two ends of the circuit breaker being affected by the outflow, and there is no need to reserve a large safety distance at both ends, which can realize the miniaturization of the entire circuit breaker. At the same time, by arranging the first arc protection element 40 behind the first arc extinguishing chamber at the first end 10 without the air flow outlet, it can prevent the arc flash caused by the circuit breaker housing at the first end being expanded by internal pressure during the moment of short-circuit breaking, promoting the realization of zero arc flash.

In the embodiment shown in the drawings, the outlets of both air flow channels are arranged at the second end 20 of the circuit breaker, and the first arc protection element 40 is arranged at the first end 10. It can be understood that, in an unillustrated embodiment, the outlets of the first air flow channel 15 and the second air flow channel 25 may be arranged at the first end 10, and the first arc protection element 40 may be arranged at the second end 20.

The first arc protection element 40 may be any element that can achieve an arc extinguishing effect, such as metal mesh(es), arc extinguishing grid(s), etc. Preferably, the first arc protection element 40 is a plate-like element made of a metal material with multiple through-holes, such as a metal woven mesh, a metal perforated plate, or a similar structure.

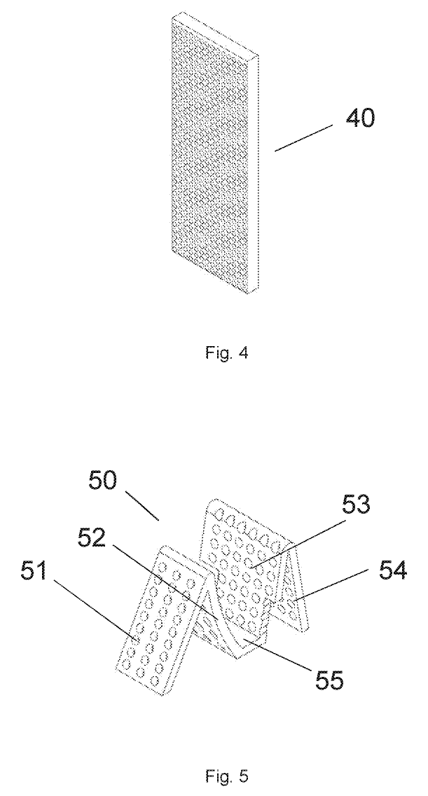

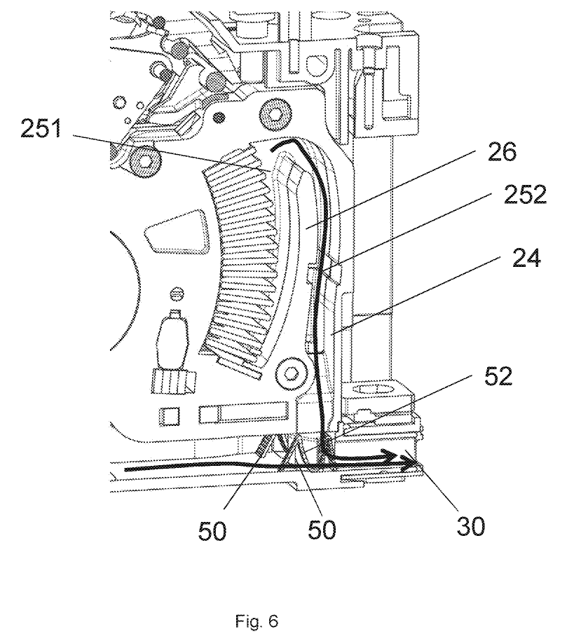

FIG. 4 shows an exemplary embodiment of the first arc protection element 40 of the present disclosure. In this embodiment, the first arc protection element 40 is a metal plate-like element with uniform thickness, having multiple through-holes. This structure is simple, easy to manufacture, and can effectively prevent the arc flash caused by the circuit breaker housing at the first end being expanded by internal pressure during the moment of short-circuit breaking.

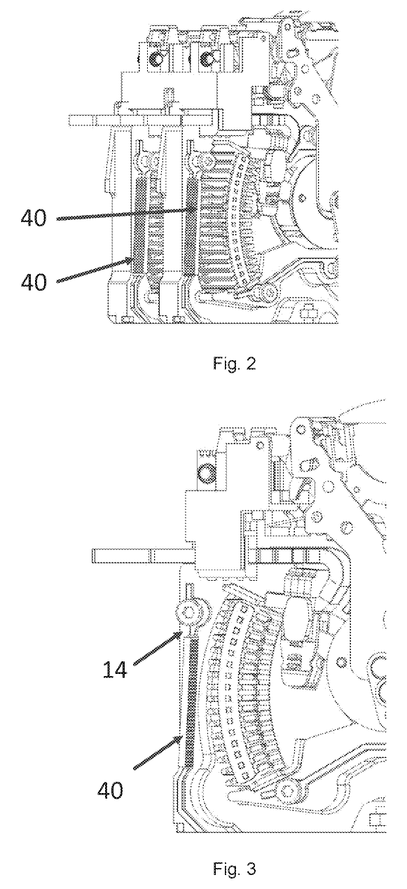

FIGS. 2 and 3 are partial views of the circuit breaker according to an exemplary embodiment of the present disclosure, particularly showing the installation position of the first arc protection element 40. It can be seen that the first end wall 14 of the first end 10 has a certain thickness, in which a groove is arranged, and the first arc protection element 40 is installed in the groove. Thus, the first arc protection element 40 can be firmly and effectively fixed in the circuit breaker housing. In an exemplary embodiment where the circuit breaker includes two half-housings joined together, a groove may be arranged in the wall of each half-housing, and the grooves of the two half-housings may be joined together to form a substantially enclosed accommodation space for the first arc protection element 40.

It should be understood that FIGS. 2 and 3 both show the case of a bipolar circuit breaker, and the previous description can be applied to any pole of the bipolar circuit breaker. The circuit breaker of the present disclosure may also be a single-pole circuit breaker, a three-pole circuit breaker, etc.

Preferably, at least one of the first air flow channel 15 and the second air flow channel 25 has one or more bending parts. By arranging bending parts, the length of the air flow channel can be increased within the limited space of the circuit breaker, which is more conducive to cooling and consuming charged particles, thereby improving the arc extinguishing effect.

Preferably, the first air flow channel 15 includes a vertical part near the rear side of the first arc extinguishing chamber and a horizontal part extending substantially along the bottom wall of the circuit breaker toward the outlet 30.

As mentioned above, in an exemplary embodiment, the second air flow channel 25 and the first air flow channel 15 share the same outlet 30. The outlet 30 may be specifically implemented as a single outlet. In other embodiments, the outlet 30 includes two or more independent outlets. In the preferred embodiment shown in the drawings, for each pole of the circuit breaker, the outlet 30 includes a first outlet and a second outlet spaced apart in the thickness direction of the circuit breaker.

In an exemplary embodiment, the second air flow channel 25 and the first air flow channel 15 merge after the air flow intersects and lead to the same outlet. The present disclosure refers to the area where the second air flow channel 25 and the first air flow channel 15 intersect as the junction area. According to an exemplary embodiment of the present disclosure, a second arc protection element 50 is arranged in the junction area of the first air flow channel 15 and the second air flow channel 25. The first air flow channel 15 and the second air flow channel 25 may intersect in one or more junction areas. Preferably, a second arc protection element 50 is arranged at each junction area.

The second arc protection element 50 may be any element that can achieve an arc extinguishing effect, such as metal mesh(es), arc extinguishing grid(s), etc. Preferably, the second arc protection element 50 includes one or more arc protection mesh surfaces. The arc protection mesh surface is a plate-like or sheet-like structure with multiple through-holes. Each arc protection mesh surface is arranged to allow gas from the first air flow channel 15 and/or the second air flow channel 25 to pass through. During the process of the gas passing through the second arc protection element 50, the charged particles are rapidly cooled, thereby reducing the emission of charged particles.

FIG. 5 shows an exemplary embodiment of the second arc protection element 50. This second arc protection element 50 includes four arc protection mesh surfaces, namely a first arc protection mesh surface 51, a second arc protection mesh surface 52, a third arc protection mesh surface 53, and a fourth arc protection mesh surface 54. Preferably, adjacent arc protection mesh surfaces are connected at an acute angle. For example, the first arc protection mesh surface 51 is connected to the second arc protection mesh surface 52 at an acute angle, and the third arc protection mesh surface 53 is connected to the fourth arc protection mesh surface 54 at an acute angle.

In other embodiments not shown, the second arc protection element 50 may have more or fewer arc protection mesh surfaces, and the arc protection mesh surfaces may have other arrangements, as long as the gas can flow through the arc protection mesh surfaces.

Preferably, at least one of the one or more arc protection mesh surfaces also serves as an air flow guiding surface. In the embodiment of FIG. 5, the second arc protection mesh surface 52 serves as an air flow guiding surface. The air flow guiding surface has a curved surface to guide the vertical air flow in the second air flow channel 25 toward the direction of the outlet 30, avoiding the vertical air flow in the second air flow channel 25 flowing back in the direction away from the outlet 30.

The second arc protection element 50 further includes a fixing surface 55. The fixing surface 55 is preferably a plane parallel to the channel side wall, which engages the channel side wall to assist in fixing the second arc protection element 50. The second arc protection element 50 is preferably installed at the junction area of the first air flow channel and the second air flow channel by latching or the like. Alternatively, the second arc protection element 50 may be welded to the housing structure of the circuit breaker at the fixing surface 55.

Preferably, the second arc protection element 50 is formed by bending a metal plate-like element, so that the second arc protection element 50 has a simple structure, which is easy to process and manufacture.

As shown in FIG. 1, preferably, the inlet size of the first air flow channel 15 is greater than or equal to the length of the end 132 of the first arc extinguishing chamber 13, and/or the inlet size of the second air flow channel 25 is greater than or equal to the length of the end 232 of the second arc extinguishing chamber 23. In other words, the width of the air flow channel inlet can span or exceed the entire end of the arc extinguishing chamber, so that the gas flowing out of the arc extinguishing chamber can directly enter the corresponding air flow channel. Moreover, the ultra-wide air flow channel inlet in combination with the strip-like guiding part introduced below can form an air flow path that is both good in flow performance and can have a longer length in a compact space.

Preferably, the circuit breaker has a strip-like guiding part 26 extending between the rear side 232 of the second arc extinguishing chamber and the second end wall 24 of the circuit breaker housing at the second end 20. The strip-like guiding part 26 extends approximately in the y-direction, i.e., in the same direction as the height of the arc extinguishing chamber or the height of the circuit breaker. Through the strip-like guiding part 26, the second air flow channel 25 forms an approximately 180-degree turn, forming a first channel part 251 defined by the rear side 232 of the arc extinguishing chamber and the strip-like guiding part 26, and a second channel part 252 connected to the first channel part 251 and defined by the second end wall 24 and the strip-like guiding part 26. The first channel part 251 extends approximately upward in the y-direction, i.e., toward the top of the circuit breaker, and the second channel part 252 extends approximately downward in the y-direction, i.e., toward the bottom of the circuit breaker. Compared to the scheme without the strip-like guiding part 26, the length of the second air flow channel 25 is greatly increased.

The second channel part 252 of the second air flow channel 25 merges with the first air flow channel 15 and flows together toward the outlet 30. Preferably, the outlet 30 includes a first outlet and a second outlet, the junction area includes a first junction area and a second junction area leading to the first outlet and the second outlet respectively, and after passing through the first junction area and the second junction area, the gas flows toward the first outlet and the second outlet respectively.

Preferably, the outlet is arranged at the bottom of the circuit breaker. Particularly, the outlet may be arranged below the fixed contact assembly 111. By such an arrangement, the lengths of the first air flow channel and the second air flow channel can be balanced.

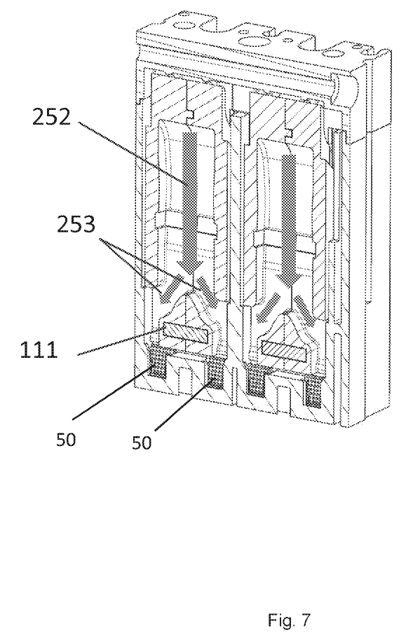

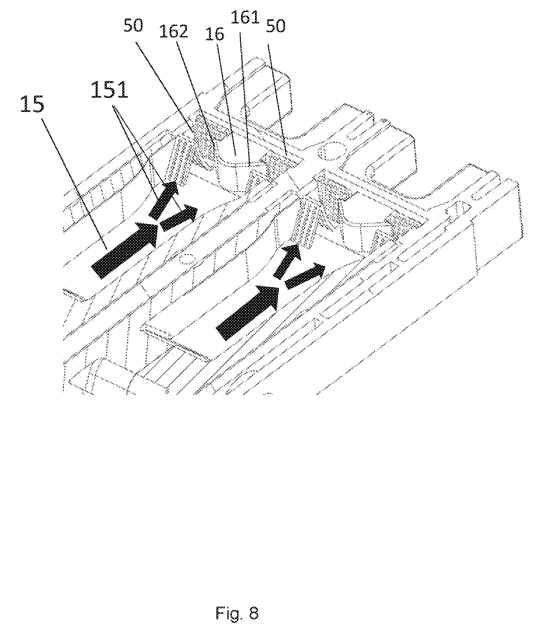

FIG. 7 shows a cross-sectional view of a circuit breaker according to an exemplary embodiment of the present disclosure, showing the second channel part 252 of the second air flow channel 25. Preferably, the second channel part 252 includes two second air flow branches 253 separated by the fixed contact assembly 111. FIG. 8 shows another cross-sectional view of a circuit breaker according to an exemplary embodiment of the present disclosure, showing the end of the first air flow channel 15. Preferably, the first air flow channel 15 is divided into two first air flow branches 151 by a partition structure 16. Preferably, the two second air flow branches 253 of the second air flow channel 25 and the two first air flow branches 151 of the first air flow channel 15 respectively intersect, forming a first junction area and a second junction area. Preferably, a second arc protection element 50 is arranged in both the first junction area and the second junction area.

The embodiments shown in FIGS. 7 and 8 involve a bipolar circuit breaker, and the components and arrangements of the two poles of the circuit breaker are basically the same. The previous description can be applied to any pole of the bipolar circuit breaker. In an unillustrated embodiment, the circuit breaker may be a single-pole circuit breaker, a three-pole circuit breaker, etc.

Preferably, as shown in FIG. 8, the partition structure 16 preferably has a flow guidance curved surface 161 facing the upstream direction of the first air flow channel 15 and two latching parts 162 located on both sides of the flow guidance curved surface 161. The latching parts 162 can engage with the second arc protection element 50 to facilitate the positioning of the second arc protection element 50 relative to the circuit breaker housing. Preferably, the circuit breaker housing is also provided with a latching structure for positioning the second arc protection element 50.

The exemplary embodiments of the technical solutions proposed in the present disclosure have been described in detail above in reference to preferred embodiments. However, it should be understood by those skilled in the art that various modifications and variations can be made to the above-described specific embodiments without departing from the spirit of the present disclosure, and various technical features and structures proposed in the present disclosure can be combined in many ways without exceeding the scope of the present disclosure. The scope of protection of the present disclosure is defined by the appended claims.

What is claimed is:

1. A circuit breaker comprising a first end and a second end opposing each other, and the following components located between the first end and the second end:
a first set of moving and fixed contacts;
a first arc extinguishing chamber having a front side spaced apart at a first distance from the first set of moving and fixed contacts and a rear side spaced apart at a second distance from the first set of moving and fixed contacts, the second distance being greater than the first distance;
a second set of moving and fixed contacts;
a second arc extinguishing chamber having a front side close to the second set of moving and fixed contacts and a rear side distant from the second set of moving and fixed contacts;
wherein the circuit breaker further comprises a first air flow channel starting from the rear side of the first arc extinguishing chamber and a second air flow channel starting from the rear side of the second arc extinguishing chamber, and wherein one or more outlets arranged at the second end are fluidly coupled to the first air flow channel and the second air flow channel; and
wherein a first arc protection element is arranged at the first end, located between the rear side of the first arc extinguishing chamber and the outer surface of the first end wall of the first end.

2. The circuit breaker according to claim 1, wherein a groove is arranged in the first end wall of the first end, and the first arc protection element is installed in the groove.

3. The circuit breaker according to claim 1, wherein the first arc protection element is a plate-like element with multiple through-holes.

4. The circuit breaker according to claim 3, wherein the first arc protection element is a metal woven mesh or a metal perforated plate.

5. The circuit breaker according to claim 1, wherein the second air flow channel and the first air flow channel lead to the same outlet.

6. The circuit breaker according to claim 5, wherein a second arc protection element is arranged in the junction area of the first air flow channel and the second air flow channel.

7. The circuit breaker according to claim 6, wherein the second arc protection element includes one or more arc protection mesh surfaces arranged to allow gas from the first air flow channel and/or the second air flow channel to pass through.

8. The circuit breaker according to claim 7, wherein at least one of the one or more arc protection mesh surfaces also serves as an air flow guiding surface, the air flow guiding surface having a curved surface to guide the gas in the second air flow channel toward the direction of the outlet.

9. The circuit breaker according to claim 7, wherein the second arc protection element further includes a fixing surface engaging the channel side wall to assist in fixing the second arc protection element.

10. The circuit breaker according to claim 6, wherein the second arc protection element is formed by bending a metal plate-like element.

11. The circuit breaker according to claim 6, wherein the outlet includes a first outlet and a second outlet, the junction area includes a first junction area and a second junction area leading to the first outlet and the second outlet respectively, and the second arc protection element is arranged in both the first junction area and the second junction area.

12. The circuit breaker according to claim 1, wherein the outlet is arranged at the bottom of the circuit breaker.

13. A circuit breaker comprising a first end and a second end opposing each other, and the following components located between the first end and the second end:
a first set of moving and fixed contacts;
a first arc extinguishing chamber having a front side spaced apart at a first distance from the first set of moving and fixed contacts and a rear side spaced apart at a second distance from the first set of moving and fixed contacts, the second distance being greater than the first distance;
a second set of moving and fixed contacts;
a second arc extinguishing chamber having a front side close to the second set of moving and fixed contacts and a rear side distant from the second set of moving and fixed contacts;
wherein the circuit breaker further comprises a first air flow channel starting from the rear side of the first arc extinguishing chamber and a second air flow channel starting from the rear side of the second arc extinguishing chamber, and outlets of both the first air flow channel and the second air flow channel are arranged at the second end; and
wherein a first arc protection element is arranged at the first end, located between the rear side of the first arc extinguishing chamber and the outer surface of the first end wall of the first end; wherein the first arc protection element is a plate-like element with multiple through-holes and is disposed in a groove formed in the first end wall of the first end.

14. The circuit breaker according to claim 13, wherein the first arc protection element is a metal woven mesh or a metal perforated plate.

15. The circuit breaker according to claim 13, wherein the second air flow channel and the first air flow channel lead to the same outlet.

16. The circuit breaker according to claim 15, wherein a second arc protection element is arranged in the junction area of the first air flow channel and the second air flow channel.

17. The circuit breaker according to claim 16, wherein the second arc protection element includes one or more arc protection mesh surfaces arranged to allow gas from the first air flow channel and/or the second air flow channel to pass through.

18. The circuit breaker according to claim 17, wherein at least one of the one or more arc protection mesh surfaces also serves as an air flow guiding surface, the air flow guiding surface having a curved surface to guide the gas in the second air flow channel toward the direction of the outlet.

19. The circuit breaker according to claim 17, wherein the second arc protection element further includes a fixing surface engaging the channel side wall to assist in fixing the second arc protection element.

20. The circuit breaker according to claim 16, wherein the second arc protection element is formed by bending a metal plate-like element.
